(19) United States
(12) Patent Application Publication
(10) Pub. No.: US 2026/0057152 A1
(43) Pub. Date: Feb. 26, 2026

(54) TRAINING TRANSFORMER MODELS TO GENERATE MECHANICAL ASSEMBLIES

(71) Applicant: AUTODESK, INC., San Francisco, CA (US)

(72) Inventors: Hyunmin CHEONG, Toronto (CA); Mohammadmehdi ATAEI, Toronto (CA); Pradeep Kumar JAYARAMAN, Toronto (CA); Yasaman ETESAM, Vancouver (CA)

(21) Appl. No.: 19/262,792

(22) Filed: Jul. 8, 2025

Related U.S. Application Data
(60) Provisional application No. 63/686,111, filed on Aug. 22, 2024.

(51) Int. Cl. G06F 30/27; G06F 30/17; G06F 111/20

(52) U.S. Cl. CPC G06F 30/27; G06F 30/17; G06F 2111/20

(57) ABSTRACT

Techniques are disclosed for generating training datasets and training generative artificial intelligence (AI) models for mechanical assembly designs. A method includes receiving a catalog of mechanical parts and generating a parts grammar that defines compatibility relationships between the parts. Using the parts grammar, one or more combined mechanical assemblies are generated, each comprising compatible mechanical parts. Assembly metrics are then generated by applying one or more physics simulations to the combined mechanical assemblies. A dataset is created based on the assemblies and corresponding assembly metrics, and used to train a generative AI model. Training includes executing an iterative training process in which assembly metrics are provided as input to the generative AI model to generate predicted assemblies, comparing the predicted assemblies to ground truth assemblies to compute a transformer loss and a complexity loss, and updating model weights based on an aggregated loss metric until a convergence threshold is satisfied.

### CROSS-REFERENCE TO RELATED APPLICATIONS

The present application claims the benefit of U.S. Provisional application titled, “INTEGRATING DEEP GENERATIVE MODELS WITH SEARCH TECHNIQUES TO RESOLVE MECHANICAL CONFIGURATION DESIGN PROBLEMS,” filed on Aug. 22, 2024, and having Ser. No. 63/686,111. The subject matter of this related application is hereby incorporated herein by reference.

### BACKGROUND

### Field of the Various Embodiments

Embodiments of the present disclosure relate generally to computer science, artificial intelligence, and mechanical system design, and, more specifically, to training transformer models to generate mechanical assemblies.

### Description of the Related Art

Mechanical system design frequently necessitates the interfacing of multiple components originating from different manufacturers. Off-the-shelf components must be arranged to satisfy system-level constraints, including volume, weight, cost, and related design limitations. Each component may impose specific structural, spatial, or functional constraints, which can restrict compatibility with other components. Consequently, determining a mechanically functional configuration that satisfies all applicable constraints presents a significant technical challenge.

Conventional automated design methods typically formulate mechanical system design as a combinatorial optimization problem. This formulation seeks to identify an optimal configuration from a set of discrete component options, with such identification being subject to constraint satisfaction. Optimization algorithms, including evolutionary algorithms, simulated annealing, and Monte Carlo tree search, have been applied to this problem structure. Each candidate configuration is evaluated using black-box physics simulations to verify compliance with specified performance and functional requirements.

One drawback of the foregoing approach is that the foregoing approach is computationally inefficient. Specifically, searching across a high-dimensional configuration space, combined with performing repeated physics-based evaluations, results in excessive processing time and significant resource usage. Moreover, execution latency and evaluation costs increase rapidly with design complexity, thereby limiting the identification of high-quality configurations within a feasible computational budget.

Another drawback of the foregoing approach is the inability to provide interactive feedback during the design process. In particular, conventional systems operate in a non-iterative manner, without displaying intermediate results or supporting dynamic adjustment of constraints. This lack of interactivity hinders the exploration of alternate configurations and prevents real-time assessment of constraint effects or design trade-offs, which negatively impacts the overall quality and quantity of generated information.

Yet another drawback of the foregoing approach is the instability and inefficiency in generated configurations. Specifically, stochastic behavior and path dependence inherent to common optimization algorithms can result in unnecessary structural complexity, increased material usage, or degraded performance relative to more optimal alternatives. Consequently, many configurations are inefficient because the algorithms terminate at solutions that are only locally optimal, rather than identifying the best possible overall designs.

As the foregoing illustrates, there is a need in the art for more effective techniques for implementing learning video environments.

### SUMMARY

One embodiment sets forth a computer-implemented method for generating datasets for training generative artificial intelligence (AI) models. According to some embodiments, the method includes the steps of receiving a mechanical parts catalog that includes a plurality of mechanical parts; generating a parts grammar based on the mechanical parts catalog, wherein the parts grammar defines, for each mechanical part included in the plurality of mechanical parts, compatibility information between the mechanical part and at least one other mechanical part included in the plurality of mechanical parts; generating, based on the parts grammar, at least one combined mechanical assembly that includes at least two mechanical parts that are compatible with one another; generating assembly metrics based on at least one physics simulation applied to the at least one combined mechanical assembly; generating at least one dataset based on the at least one combined mechanical assembly and the assembly metrics; and training at least one generative AI model based on the at least one dataset.

Another embodiment sets forth a method for training generative AI models. According to some embodiments, the method includes the steps of receiving at least one dataset that includes a plurality of combined mechanical assemblies and assembly metrics; and executing an iterative training process comprising: providing, to a generative AI model as input, the assembly metrics to cause the generative AI model to output a plurality of predicted combined mechanical assemblies; comparing the plurality of predicted combined mechanical assemblies to the plurality of combined mechanical assemblies to generate a transformer loss metric and a complexity loss metric; aggregating the transformer loss metric and the complexity loss metric to generate an aggregated loss metric; updating a plurality of training weights associated with the generative AI model based on the aggregated loss metric; and repeating the iterative training process until a convergence threshold associated with the generative AI model is satisfied.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques provide the ability to sample valid mechanical system designs in real time. This functionality enables rapid iteration and evaluation of multiple solution pathways within fixed time constraints. Another technical advantage involves the support for interactive design workflows. By enabling sampling of complete mechanical system configurations from partially specified designs, the disclosed techniques facilitate exploration of alternative design approaches within a single design cycle. The interactivity permits the direct incorporation of domain-specific knowledge and real-time feedback into the design process, which results in improved design outcomes. A further technical advantage includes increased design efficiency. The disclosed transformer-based models are trained to generate minimal-weight and minimal-cost mechanical system configurations that satisfy specified constraints, thereby enabling material and cost reductions that cannot be achieved using conventional techniques.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a block diagram illustrating the machine learning server of FIG. 1 in greater detail, according to various embodiments.

FIG. 3 is a block diagram illustrating the computing device of FIG. 1 in greater detail, according to various embodiments.

FIG. 4 is a conceptual illustration of an architecture and an informational flow that can be implemented by the assembly dataset sampler of FIG. 1, according to various embodiments.

FIG. 5 illustrates a method for generating valid mechanical assembly datasets from a parts catalog, according to various embodiments.

FIG. 6 is a conceptual illustration of an architecture and an informational flow that can be implemented by the model trainer of FIG. 1, according to various embodiments.

FIG. 7 illustrates a method for training an assembly transformer model from a set of training assembly designs, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

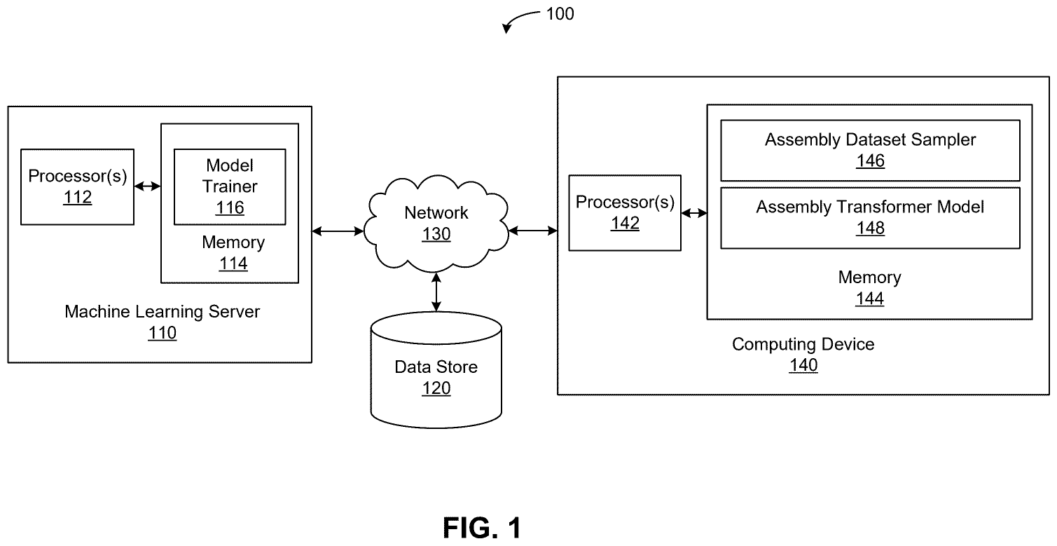

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130. The network 130 can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, which control and coordinate operations of other system components. In particular, the processor(s) 112 can issue commands that control the operation of one or more graphics processing units (GPUs) (not shown) and/or other parallel processing circuitry, such as parallel processing units or deep learning accelerators, that incorporate circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment. Such an environment can be a public, private, or a hybrid cloud system.

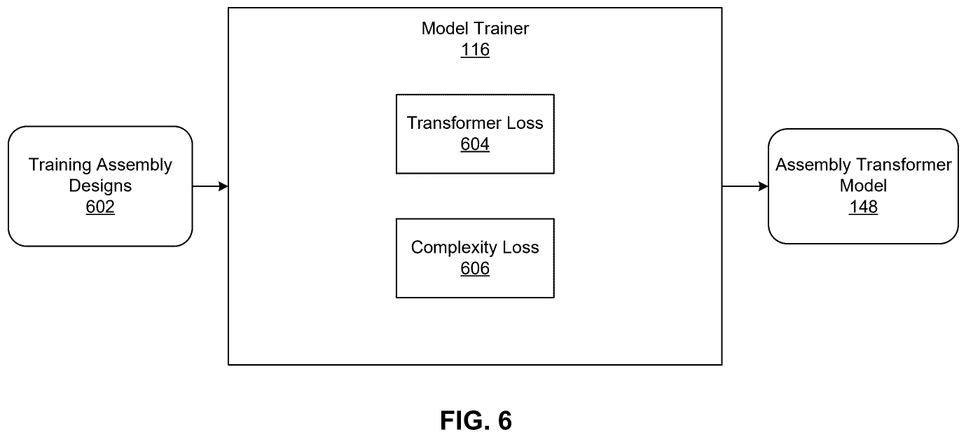

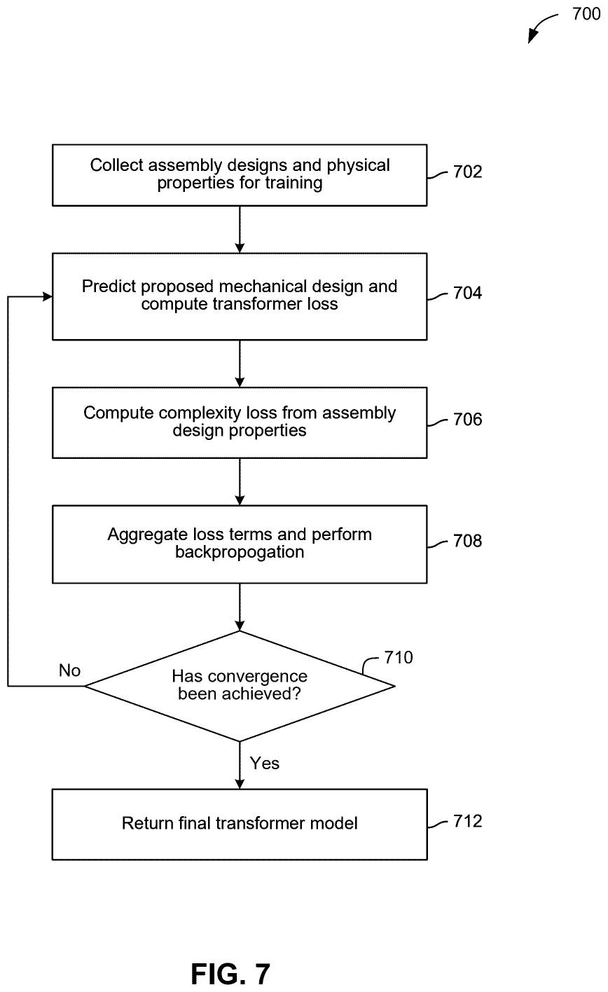

In some embodiments, the model trainer 116 is configured to train one or more machine learning models, including an assembly transformer model 148. Techniques that the model trainer 116 can use to train the machine learning model(s) are discussed in greater detail below in conjunction with FIGS. 6-7. Training data and/or trained (or deployed) machine learning models, including data generated by an assembly dataset sampler 146, can be stored in the data store 120. In some embodiments, the data store 120 can include any storage device or devices, such as fixed disc drives, flash drives, optical storage, network attached storage (NAS), and/or a storage area-network (SAN). Although shown as accessible over the network 130, in at least one embodiment, the machine learning server 110 can include the data store 120.

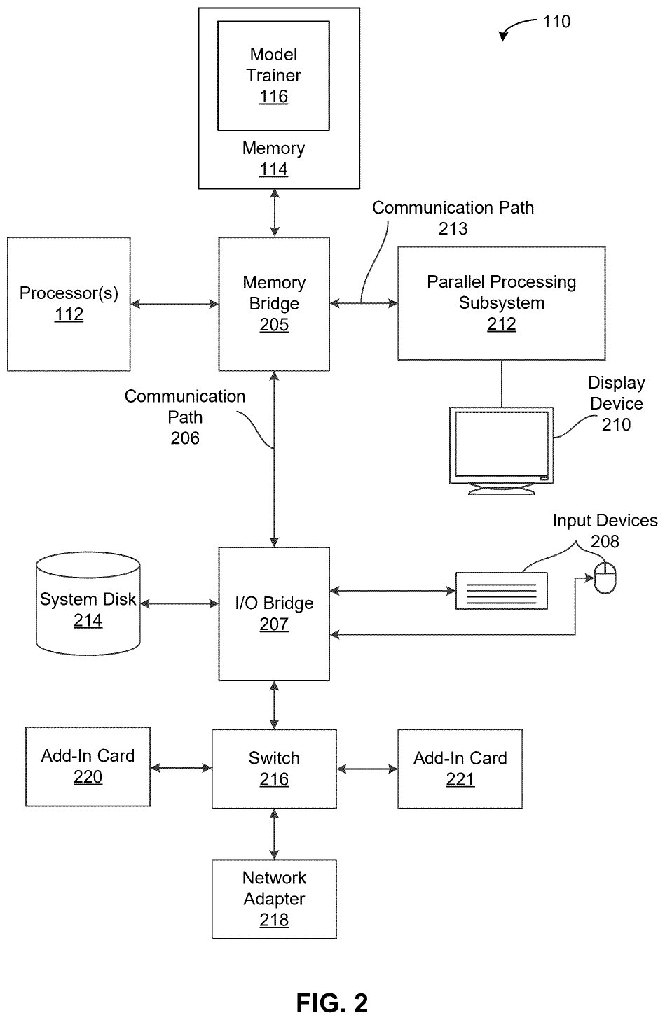

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a handheld/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory (IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (SoC).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

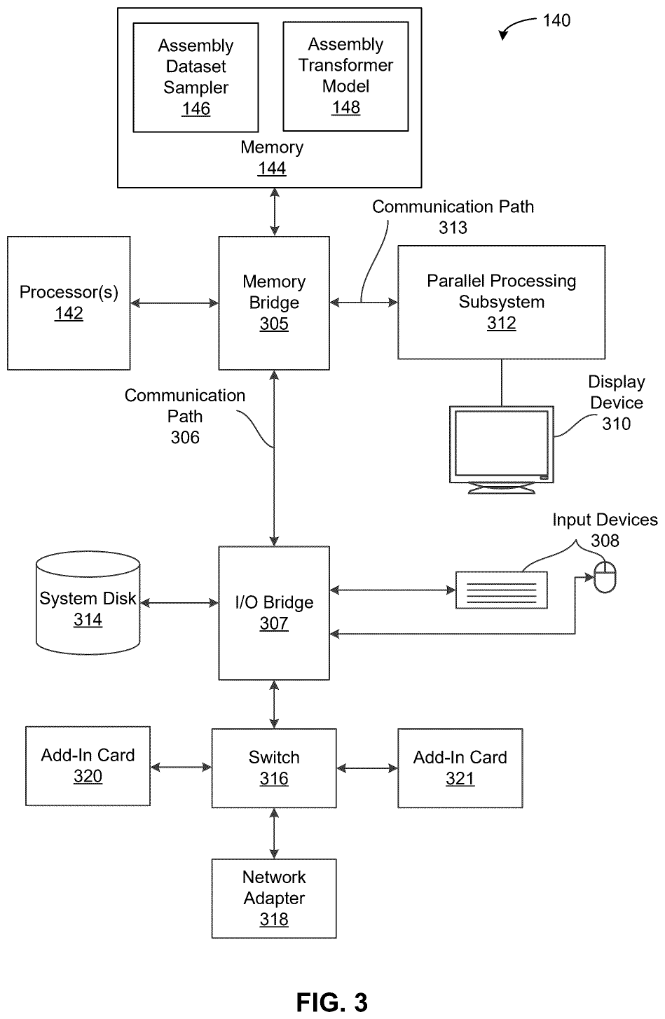

FIG. 3 is a block diagram illustrating the computing device 140 of FIG. 1 in greater detail, according to various embodiments. Computing device 140 may be any type of computing system, including, without limitation, a server machine, a server platform, a desktop machine, a laptop machine, a handheld/mobile device, a digital kiosk, or a wearable device. In some embodiments, computing device 140 is a server machine operating in a data center or a cloud computing environment that provides scalable computing resources as a service over a network.

In various embodiments, computing device 140 includes, without limitation, the processor(s) 142 and the memory (IES) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via the network adapter 318. In some embodiments, switch 316 is configured to provide connections between I/O bridge 307 and other components of the assembly dataset sampler 146 and the assembly transformer model 148, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a northbridge chip, and I/O bridge 307 may be a southbridge chip. In addition, communication paths 306 and 313, as well as other communication paths within the assembly dataset sampler 146 and the assembly transformer model 148, may be implemented using any technically suitable protocols, including, without limitation, AGP (accelerated graphics port), hypertransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312. In various embodiments, the parallel processing subsystem 312 incorporates circuitry optimized for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

System memory 144 includes at least one device driver configured to manage the processing operations of the one or more PPUs within parallel processing subsystem 312. In addition, the system memory 144 includes the assembly dataset sampler 146 and the assembly transformer model 148. Although described herein primarily with respect to the assembly dataset sampler 146 and the assembly transformer model 148, techniques disclosed herein can also be implemented, either entirely or in part, in other software and/or hardware, such as in the parallel processing subsystem 312.

In some embodiments, processor(s) 142 includes the primary processor of the assembly dataset sampler 146 and the assembly transformer model 148, controlling and coordinating operations of other system components. In some embodiments, the processor(s) 142 issues commands that control the operation of PPUs. In some embodiments, communication path 313 is a PCI express link, in which dedicated lanes are allocated to each PPU. Other communication paths may also be used. The PPU advantageously implements a highly parallel processing architecture, and the PPU may be provided with any amount of local parallel processing memory (pp memory).

It will be appreciated that the system shown herein is illustrative and that variations and modifications are possible. The connection topology, including the number and arrangement of bridges or the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Assembly Dataset Sampler

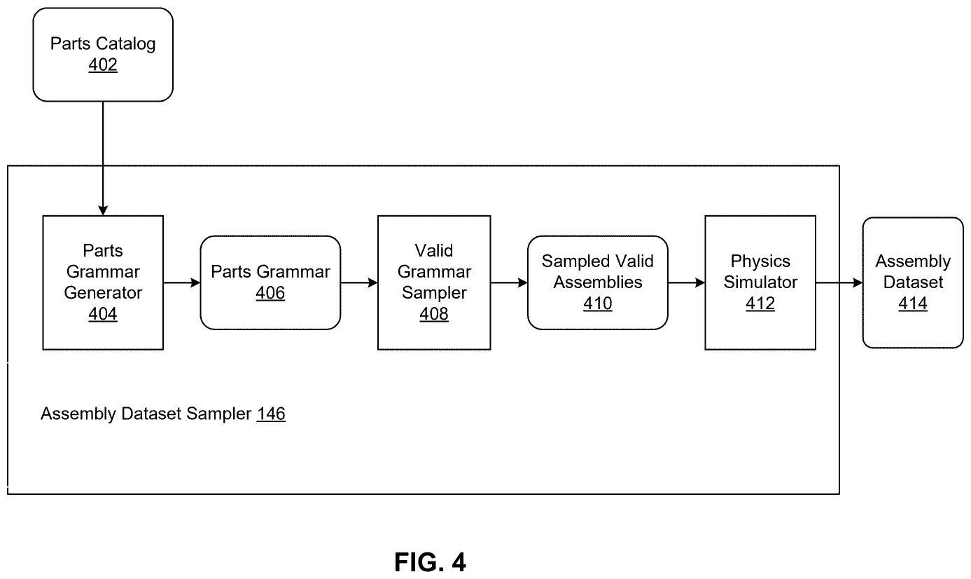

FIG. 4 provides a more detailed illustration of the assembly dataset sampler 146 illustrated in FIG. 1, according to various embodiments. As shown in FIG. 4, the assembly dataset sampler 146 includes a parts grammar generator 404, a valid grammar sampler 408, and a physics simulator 412 that operate sequentially to generate an assembly dataset 414 from a parts catalog 402.

The parts catalog 402 is a collection of mechanical parts available to a designer for use in a specific assembly design. In some embodiments, the parts listed in the parts catalog 402 include various components such as gears and shafts that can be connected in multiple ways and orientations to generate assemblies for executing mechanical tasks. The parts grammar generator 404 accepts the parts catalog 402 as input and generates a parts grammar 406 as output. The parts grammar generator 404 translates the human-readable list of parts into a transformer-compatible collection of part identifiers and assembly rules. The parts grammar generator 404 first generates a list of tokens to identify each individual part listed in the parts catalog 402. The parts grammar generator 404 then defines translation and orientation tokens to describe the placement and orientation of a given part. The parts grammar generator 404 also defines mesh tokens, which specify the relative orientation and mechanism by which two parts are connected. In some embodiments, the mesh tokens define how gears connect with one another or in which direction a gear shaft is oriented. Finally, the parts grammar generator 404 defines a start and end token. This collection of tokens and rules is returned as the parts grammar 406.

The valid grammar sampler 408 accepts the parts grammar 406 as input and generates sampled valid assemblies 410 as output. The valid grammar sampler 408 generates sequences of part and orientation tokens that comply with the rules defined in the parts grammar 406. In some embodiments, the sampling of part and orientation tokens is performed sequentially. For example, a random part is selected from the part list in the parts grammar 406, along with a random orientation. Then, an additional part and orientation are sampled, and a valid mesh token is generated that can join them, if feasible. If the parts cannot be joined, one or both are resampled. This process continues until the assembly reaches a predefined size. This process is repeated until a sufficient number of valid assemblies is generated. This collection of valid assemblies is returned as the valid assemblies 410.

The physics simulator 412 accepts the valid assemblies 410 as input and generates the assembly dataset 414 as output. The physics simulator 412 utilizes physics simulating software to determine which assemblies of the valid assemblies 410 are physically feasible. Some assemblies may be valid according to the parts grammar 406 but cannot be assembled physically for other reasons. For example, one valid assembly 410 may generate a collection of gears and shafts that overlap physically in space and, therefore, would not be physically feasible. Assemblies that are physically invalid are rejected. For valid assemblies 410 that are physically feasible, the physics simulator 412 also computes the physical properties of the assembly. In some embodiments, the physics simulator 412 computes the weight and volume of an assembly. The list of physically feasible assemblies, along with their accompanying physical properties, is returned as the assembly dataset 414.

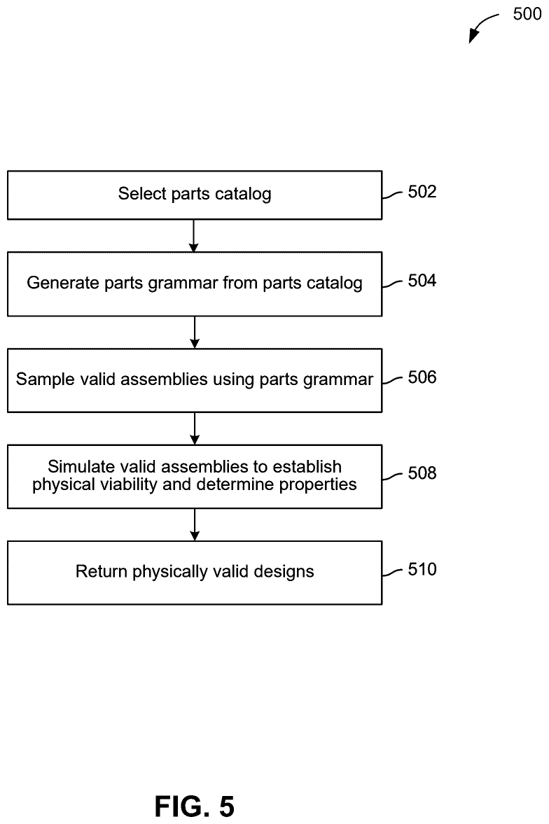

FIG. 5 sets forth a flow diagram of method steps for sampling machine assembly datasets, according to various embodiments. Although the method steps are described in conjunction with the systems shown in FIGS. 1-4, individuals skilled in the art will understand that any system configured to perform the method steps in any order falls within the scope of the present disclosure.

As shown, method 500 begins at step 502, where the assembly dataset sampler 146 receives a parts catalog 402 for processing to generate an assembly dataset 414. The parts catalog 402 can be a collection of mechanical parts available for use in a relevant assembly line. For example, in some embodiments, the parts catalog 402 may consist of available gears and shafts that can be purchased from a manufacturer.

At step 504, the parts grammar generator 404 uses the parts catalog 402 to generate a parts grammar 406. The parts grammar 406 defines a list of available parts, along with orientation and mesh tokens in a transformer-compatible format. For example, in some embodiments, the parts grammar 406 defines a valid list of available parts in the parts catalog 402. Then, the parts grammar 406 defines orientation and translation tokens for those parts and defines valid mechanisms by which those parts may be joined, according to specifications in the parts catalog 402. This list of parts and rule tokens, along with special start and end tokens, are returned as the parts grammar 406.

At step 506, the valid grammar sampler 408 accepts the parts grammar 406 as input and generates sampled valid assemblies 410 as output. The valid grammar sampler 408 samples random parts tokens from the parts grammar 406 and attempts to join them together with mesh tokens in a valid fashion, up to a predefined sequence length. Parts that cannot be validly joined are rejected. This process repeats until a predefined number of the sampled valid assemblies 410 is reached.

At step 508, the physics simulator 412 accepts the sampled valid assemblies 410 as input. The physics simulator 412 simulates each mechanical design of the sampled valid assemblies 410 and determines if each assembly is physically possible to construct. For example, in some embodiments, an assembly may be valid according to the parts grammar 406 but not may be possible to build physically. For example, a sequence of parts may be able to be joined together one after the other, but result in two parts having to occupy the same physical space, which would be invalid. If an assembly is physically viable, then the physics simulator 412 computes relevant physical properties of the assembly. For example, in some embodiments, the weight, volume, and monetary cost are computed.

At step 510, designs that are physically invalid are removed, and the physics simulator 412 returns the remaining designs and the corresponding physical properties as the assembly dataset 414.

### Training of Assembly Transformer

FIG. 6 provides a more detailed illustration of the model trainer 116 illustrated in FIG. 1, according to some embodiments. As shown, the model trainer 116 consists of a transformer loss 604 and a complexity loss 606, which operate to generate an assembly transformer model 148 from training assembly designs 602.

The model trainer 116 accepts training assembly designs 602 as input. The training assembly designs 602 is a collection of assembly designs in a transformer-compatible format, along with the corresponding physical specifications of the assembly designs. In some embodiments, the training assembly designs 602 are sampled via a procedure similar to that generating an assembly dataset 414. However, any valid machine assembly and physical constraints are sufficient. The physical specifications may include the volume, weight, or monetary cost of the assembly design, according to some embodiments.

The transformer loss 604 consists of the standard training procedure for a transformer model that maps a sequence of input tokens to a valid sequence of output tokens. In this application, transformer loss 604 seeks to train a transformer to map from a list of physical requirements for a given mechanical assembly to a valid mechanical assembly design. This is performed by using a transformer model to compute a predicted mechanical assembly design given the physical specifications of training assembly designs 602. This predicted mechanical assembly design is compared to the assembly designs of the training assembly designs 602, and a loss is computed from the difference.

The complexity loss 606 extends the transformer loss 604 to penalize overly complex mechanical assembly designs. For a given set of physical specifications, many mechanical assembly designs may be valid. In this situation, the mechanical assembly design that is minimal on some important criteria is preferred. In some embodiments, that minimization criteria may be weight, volume, or cost. The complexity loss 606 computes a penalty for this minimization criteria.

The transformer loss 604 and the complexity loss 606 are aggregated, combined, etc., to generate a final loss function for the model trainer 116. The model trainer 116 executes a training procedure that, upon achieving specific convergence criteria, generates the assembly transformer model 148.

FIG. 7 sets forth a flow diagram of method steps for training the assembly transformer model 148, according to various embodiments. Although the method steps are described in conjunction with the systems of FIGS. 1-6, persons skilled in the art will understand that any system configured to perform the method steps in any order falls within the scope of the present disclosure.

As shown, a method 700 begins at step 702, where the model trainer 116 receives the training assembly designs 602. The training assembly designs 602 are a collection of token sequences representing various mechanical assemblies, along with a collection of relevant physical properties associated with the training assembly designs 602. The transformer model 608 is trained to generate valid mechanical system designs provided in the constraints set forth by the physical properties.

At step 704, the standard transformer loss 604 is computed by generating a proposed mechanical assembly design given the physical properties and comparing the proposed mechanical assembly design to the corresponding mechanical assembly design of the training assembly designs 602.

At step 706, the complexity loss 606 computes an additional loss term, the complexity loss, which seeks to minimize the complexity of the proposed mechanical assembly design by penalizing complexity. In some embodiments, this is achieved by computing the weight of the proposed mechanical assembly and multiplying the weight by a complexity factor.

At step 708, the transformer loss 604 and the complexity loss 606 are aggregated, combined, etc., to compute the total loss. Then, backpropagation is computed using this total loss, and the weights of the assembly transformer model 148 are updated. At step 710, the convergence criteria of the training algorithm are assessed. If the convergence criteria have been achieved, then the method proceeds to step 712 and returns the assembly transformer model 148. If the convergence criteria have not been achieved, then the process returns to step 704, and steps 704-710 iterate until the convergence criteria have been achieved.

In sum, the disclosed techniques are directed toward the automated generation of mechanical system designs through the use of deep transformer models. Specifically, in various embodiments, a mechanical grammar is constructed from a catalog of available mechanical parts. Rules of the mechanical grammar dictate that adjacent parts must be mechanically compatible. Utilizing the mechanical grammar, a sample of valid part configurations is generated. Each valid configuration undergoes simulation with a physics simulator to evaluate properties such as weight, cost, and volume. Such valid part configurations, along with corresponding physical properties, constitute the training data for a transformer model designed to predict mechanical part configurations when presented with a set of physical constraints. In some embodiments, the loss function of the transformer model is modified to encourage the transformer model to generate efficient designs that minimize a given constraint. Ultimately, the resulting trained transformer model is employed to generate mechanical system designs in alignment with specified constraints.

At least one technical advantage of the disclosed techniques relative to the prior art is that the disclosed techniques provide the ability to sample valid mechanical system designs in real time. This functionality enables rapid iteration and evaluation of multiple solution pathways within fixed time constraints. Another technical advantage involves the support for interactive design workflows. By enabling sampling of complete mechanical system configurations from partially specified designs, the disclosed techniques facilitate exploration of alternative design approaches within a single design cycle. The interactivity permits the direct incorporation of domain-specific knowledge and real-time feedback into the design process, which results in improved design outcomes. A further technical advantage includes increased design efficiency. The disclosed transformer-based models are trained to generate minimal-weight and minimal-cost mechanical system configurations that satisfy specified constraints, thereby enabling material and cost reductions that cannot be achieved using conventional techniques.

1. In some embodiments, a computer-implemented method for generating datasets for training generative artificial intelligence (AI) models comprises: receiving a mechanical parts catalog that includes a plurality of mechanical parts; generating a parts grammar based on the mechanical parts catalog, wherein the parts grammar defines, for each mechanical part included in the plurality of mechanical parts, compatibility information between the mechanical part and at least one other mechanical part included in the plurality of mechanical parts; generating, based on the parts grammar, at least one combined mechanical assembly that includes at least two mechanical parts that are compatible with one another; generating assembly metrics based on at least one physics simulation applied to the at least one combined mechanical assembly; generating at least one dataset based on the at least one combined mechanical assembly and the assembly metrics; and training at least one generative AI model based on the at least one dataset.

2. The computer-implemented method of clause 1, wherein the compatibility information defines at least one of interfacing information and orientation information associated with the mechanical part.

3. The computer-implemented method of clause 2, wherein the interfacing information identifies at least one approach through which the mechanical part can validly interface with at least one other mechanical part.

4. The computer-implemented method of clause 2, wherein the orientation information identifies at least one orientation by which the mechanical part can be positioned to validly interface with at least one other mechanical part.

5. The computer-implemented method of clause 1, wherein the assembly metrics include at least one of property information or performance information associated with the at least one combined mechanical assembly.

6. The computer-implemented method of clause 5, wherein the property information comprises at least one of a volume, a weight, a number of parts, or an estimated cost associated with the at least one combined mechanical assembly.

7. The computer-implemented method of clause 5, wherein the performance information comprises at least one of a structural performance characteristic, a kinematic behavior characteristic, or a thermal or durability characteristic associated with the at least one combined mechanical assembly.

8. The computer-implemented method of clause 1, wherein each mechanical part included in the plurality of mechanical parts comprises at least one of a gear, a shaft, a bearing, a bushing, a coupling, a spring, a belt, or a sprocket.

9. The computer-implemented method of clause 1, wherein the at least one physics simulation comprises modeling at least one physical interaction between the at least two mechanical parts under a specified set of operating conditions.

10. The computer-implemented method of clause 1, further comprising excluding at least one other combined mechanical assembly from the at least one dataset.

11. In some embodiments, one or more non-transitory computer readable media store instructions that, when executed by one or more processors, cause the one or more processors to generate datasets for training generative artificial intelligence (AI) models, by performing the operations of: receiving a mechanical parts catalog that includes a plurality of mechanical parts; generating a parts grammar based on the mechanical parts catalog, wherein the parts grammar defines, for each mechanical part included in the plurality of mechanical parts, compatibility information between the mechanical part and at least one other mechanical part included in the plurality of mechanical parts; generating, based on the parts grammar, at least one combined mechanical assembly that includes at least two mechanical parts that are compatible with one another; generating assembly metrics based on at least one physics simulation applied to the at least one combined mechanical assembly; generating at least one dataset based on the at least one combined mechanical assembly and the assembly metrics; and training at least one generative AI model based on the at least one dataset.

12. The one or more non-transitory computer readable media of clause 11, wherein the compatibility information defines at least one of interfacing information and orientation information associated with the mechanical part.

13. The one or more non-transitory computer readable media of clause 12, wherein the interfacing information identifies at least one approach through which the mechanical part can validly interface with at least one other mechanical part.

14. The one or more non-transitory computer readable media of clause 12, wherein the orientation information identifies at least one orientation by which the mechanical part can be positioned to validly interface with at least one other mechanical part.

15. The one or more non-transitory computer readable media of clause 11, wherein the assembly metrics include at least one of property information or performance information associated with the at least one combined mechanical assembly.

16. The one or more non-transitory computer readable media of clause 15, wherein the property information comprises at least one of a volume, a weight, a number of parts, or an estimated cost associated with the at least one combined mechanical assembly.

17. The one or more non-transitory computer readable media of clause 15, wherein the performance information comprises at least one of a structural performance characteristic, a kinematic behavior characteristic, or a thermal or durability characteristic associated with the at least one combined mechanical assembly.

18. The one or more non-transitory computer readable media of clause 11, wherein each mechanical part included in the plurality of mechanical parts comprises at least one of a gear, a shaft, a bearing, a bushing, a coupling, a spring, a belt, or a sprocket.

19. The one or more non-transitory computer readable media of clause 11, wherein the at least one physics simulation comprises modeling at least one physical interaction between the at least two mechanical parts under a specified set of operating conditions.

20. In some embodiments, a computer system comprises one or more memories that include instructions, and one or more processors that are coupled to the one or more memories and that, when executing the instructions, are configured to generate datasets for training generative artificial intelligence (AI) models, by performing the operations of: receiving a mechanical parts catalog that includes a plurality of mechanical parts; generating a parts grammar based on the mechanical parts catalog, wherein the parts grammar defines, for each mechanical part included in the plurality of mechanical parts, compatibility information between the mechanical part and at least one other mechanical part included in the plurality of mechanical parts; generating, based on the parts grammar, at least one combined mechanical assembly that includes at least two mechanical parts that are compatible with one another; generating assembly metrics based on at least one physics simulation applied to the at least one combined mechanical assembly; generating at least one dataset based on the at least one combined mechanical assembly and the assembly metrics, and training at least one generative AI model based on the at least one dataset.

21. In some embodiments, a computer-implemented method for training generative artificial intelligence (AI) models comprises: receiving at least one dataset that includes a plurality of combined mechanical assemblies and assembly metrics; and executing an iterative training process comprising: providing, to a generative AI model as input, the assembly metrics to cause the generative AI model to output a plurality of predicted combined mechanical assemblies, comparing the plurality of predicted combined mechanical assemblies to the plurality of combined mechanical assemblies to generate a transformer loss metric and a complexity loss metric, aggregating the transformer loss metric and the complexity loss metric to generate an aggregated loss metric, updating a plurality of training weights associated with the generative AI model based on the aggregated loss metric, and repeating the iterative training process until a convergence threshold associated with the generative AI model is satisfied.

22. The computer-implemented method of clause 21, wherein the complexity loss metric penalizes the generative AI model for generating a predicted combined mechanical assembly associated with a complexity score that satisfies a complexity threshold.

23. The computer-implemented method of clause 22, wherein the complexity score satisfies the complexity threshold when at least one of a weight, a size, or an estimated cost exceeds a respective threshold.

24. The computer-implemented method of clause 21, wherein the generative AI model comprises a transformer model.

25. The computer-implemented method of clause 21, wherein the transformer loss metric is based on a training procedure for a transformer model that maps a sequence of input tokens to a valid sequence of output tokens.

26. The computer-implemented method of clause 21, wherein the assembly metrics are associated with the plurality of combined mechanical assemblies.

27. The computer-implemented method of clause 21, wherein the assembly metrics include at least one of property information or performance information associated with the plurality of combined mechanical assemblies.

28. The computer-implemented method of clause 27, wherein the property information comprises at least one of a volume, a weight, a number of parts, or an estimated cost associated with at least one combined mechanical assembly included in the plurality of combined mechanical assemblies.

29. The computer-implemented method of clause 27, wherein the performance information comprises at least one of a structural performance characteristic, a kinematic behavior characteristic, or a thermal or durability characteristic associated with at least one combined mechanical assembly included in the plurality of combined mechanical assemblies.

30. The computer-implemented method of clause 21, wherein each combined mechanical assembly included in the plurality of combined mechanical assemblies includes at least one mechanical part, at the at least one mechanical part comprises at least one of a gear, a shaft, a bearing, a bushing, a coupling, a spring, a belt, or a sprocket.

31. In some embodiments, one or more non-transitory computer readable media store instructions that, when executed by one or more processors, cause the one or more processors to train generative artificial intelligence (AI) models, by performing the operations of: receiving at least one dataset that includes a plurality of combined mechanical assemblies and assembly metrics; and executing an iterative training process comprising: providing, to a generative AI model as input, the assembly metrics to cause the generative AI model to output a plurality of predicted combined mechanical assemblies, comparing the plurality of predicted combined mechanical assemblies to the plurality of combined mechanical assemblies to generate a transformer loss metric and a complexity loss metric, aggregating the transformer loss metric and the complexity loss metric to generate an aggregated loss metric, updating a plurality of training weights associated with the generative AI model based on the aggregated loss metric, and repeating the iterative training process until a convergence threshold associated with the generative AI model is satisfied.

32. The one or more non-transitory computer readable media of clause 31, wherein the complexity loss metric penalizes the generative AI model for generating a predicted combined mechanical assembly associated with a complexity score that satisfies a complexity threshold.

33. The one or more non-transitory computer readable media of clause 32, wherein the complexity score satisfies the complexity threshold when at least one of a weight, a size, or an estimated cost exceeds a respective threshold.

34. The one or more non-transitory computer readable media of clause 31, wherein the generative AI model comprises a transformer model.

35. The one or more non-transitory computer readable media of clause 31, wherein the transformer loss metric is based on a training procedure for a transformer model that maps a sequence of input tokens to a valid sequence of output tokens.

36. The one or more non-transitory computer readable media of clause 31, wherein the assembly metrics are associated with the plurality of combined mechanical assemblies.

37. The one or more non-transitory computer readable media of clause 31, wherein the assembly metrics include at least one of property information or performance information associated with the plurality of combined mechanical assemblies.

38. The one or more non-transitory computer readable media of clause 37, wherein the property information comprises at least one of a volume, a weight, a number of parts, or an estimated cost associated with at least one combined mechanical assembly included in the plurality of combined mechanical assemblies.

39. The one or more non-transitory computer readable media of clause 37, wherein the performance information comprises at least one of a structural performance characteristic, a kinematic behavior characteristic, or a thermal or durability characteristic associated with at least one combined mechanical assembly included in the plurality of combined mechanical assemblies.

40. In some embodiments, a computer system comprises one or more memories that include instructions, and one or more processors that are coupled to the one or more memories and that, when executing the instructions, are configured to train generative artificial intelligence (AI) models, by performing the operations of: receiving at least one dataset that includes a plurality of combined mechanical assemblies and assembly metrics; and executing an iterative training process comprising: providing, to a generative AI model as input, the assembly metrics to cause the generative AI model to output a plurality of predicted combined mechanical assemblies, comparing the plurality of predicted combined mechanical assemblies to the plurality of combined mechanical assemblies to generate a transformer loss metric and a complexity loss metric, aggregating the transformer loss metric and the complexity loss metric to generate an aggregated loss metric, updating a plurality of training weights associated with the generative AI model based on the aggregated loss metric, and repeating the iterative training process until a convergence threshold associated with the generative AI model is satisfied.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating datasets for training generative artificial intelligence (AI) models, the method comprising:
receiving a mechanical parts catalog that includes a plurality of mechanical parts;
generating a parts grammar based on the mechanical parts catalog, wherein the parts grammar defines, for each mechanical part included in the plurality of mechanical parts, compatibility information between the mechanical part and at least one other mechanical part included in the plurality of mechanical parts;
generating, based on the parts grammar, at least one combined mechanical assembly that includes at least two mechanical parts that are compatible with one another;
generating assembly metrics based on at least one physics simulation applied to the at least one combined mechanical assembly;
generating at least one dataset based on the at least one combined mechanical assembly and the assembly metrics; and
training at least one generative AI model based on the at least one dataset.

2. The computer-implemented method of claim 1, wherein the compatibility information defines at least one of interfacing information and orientation information associated with the mechanical part.

3. The computer-implemented method of claim 2, wherein the interfacing information identifies at least one approach through which the mechanical part can validly interface with at least one other mechanical part.

4. The computer-implemented method of claim 2, wherein the orientation information identifies at least one orientation by which the mechanical part can be positioned to validly interface with at least one other mechanical part.

5. The computer-implemented method of claim 1, wherein the assembly metrics include at least one of property information or performance information associated with the at least one combined mechanical assembly.

6. The computer-implemented method of claim 5, wherein the property information comprises at least one of a volume, a weight, a number of parts, or an estimated cost associated with the at least one combined mechanical assembly.

7. The computer-implemented method of claim 5, wherein the performance information comprises at least one of a structural performance characteristic, a kinematic behavior characteristic, or a thermal or durability characteristic associated with the at least one combined mechanical assembly.

8. The computer-implemented method of claim 1, wherein each mechanical part included in the plurality of mechanical parts comprises at least one of a gear, a shaft, a bearing, a bushing, a coupling, a spring, a belt, or a sprocket.

9. The computer-implemented method of claim 1, wherein the at least one physics simulation comprises modeling at least one physical interaction between the at least two mechanical parts under a specified set of operating conditions.

10. The computer-implemented method of claim 1, further comprising excluding at least one other combined mechanical assembly from the at least one dataset.

11. One or more non-transitory computer readable media storing instructions that, when executed by one or more processors, cause the one or more processors to generate datasets for training generative artificial intelligence (AI) models, by performing the operations of:
receiving a mechanical parts catalog that includes a plurality of mechanical parts;
generating a parts grammar based on the mechanical parts catalog, wherein the parts grammar defines, for each mechanical part included in the plurality of mechanical parts, compatibility information between the mechanical part and at least one other mechanical part included in the plurality of mechanical parts;
generating, based on the parts grammar, at least one combined mechanical assembly that includes at least two mechanical parts that are compatible with one another;
generating assembly metrics based on at least one physics simulation applied to the at least one combined mechanical assembly;
generating at least one dataset based on the at least one combined mechanical assembly and the assembly metrics; and
training at least one generative AI model based on the at least one dataset.

12. The one or more non-transitory computer readable media of claim 11, wherein the compatibility information defines at least one of interfacing information and orientation information associated with the mechanical part.

13. The one or more non-transitory computer readable media of claim 12, wherein the interfacing information identifies at least one approach through which the mechanical part can validly interface with at least one other mechanical part.

14. The one or more non-transitory computer readable media of claim 12, wherein the orientation information identifies at least one orientation by which the mechanical part can be positioned to validly interface with at least one other mechanical part.

15. The one or more non-transitory computer readable media of claim 11, wherein the assembly metrics include at least one of property information or performance information associated with the at least one combined mechanical assembly.

16. The one or more non-transitory computer readable media of claim 15, wherein the property information comprises at least one of a volume, a weight, a number of parts, or an estimated cost associated with the at least one combined mechanical assembly.

17. The one or more non-transitory computer readable media of claim 15, wherein the performance information comprises at least one of a structural performance characteristic, a kinematic behavior characteristic, or a thermal or durability characteristic associated with the at least one combined mechanical assembly.

18. The one or more non-transitory computer readable media of claim 11, wherein each mechanical part included in the plurality of mechanical parts comprises at least one of a gear, a shaft, a bearing, a bushing, a coupling, a spring, a belt, or a sprocket.

19. The one or more non-transitory computer readable media of claim 11, wherein the at least one physics simulation comprises modeling at least one physical interaction between the at least two mechanical parts under a specified set of operating conditions.

20. A computer system, comprising:
one or more memories that include instructions; and
one or more processors that are coupled to the one or more memories and, when executing the instructions, are configured to generate datasets for training generative artificial intelligence (AI) models, by performing the operations of:
receiving a mechanical parts catalog that includes a plurality of mechanical parts;
generating a parts grammar based on the mechanical parts catalog, wherein the parts grammar defines, for each mechanical part included in the plurality of mechanical parts, compatibility information between the mechanical part and at least one other mechanical part included in the plurality of mechanical parts;
generating, based on the parts grammar, at least one combined mechanical assembly that includes at least two mechanical parts that are compatible with one another;
generating assembly metrics based on at least one physics simulation applied to the at least one combined mechanical assembly;
generating at least one dataset based on the at least one combined mechanical assembly and the assembly metrics; and
training at least one generative AI model based on the at least one dataset.
